(19) United States
(12) Patent Application Publication
(10) Pub. No.: US 2002/0107017 A1
(43) Pub. Date: Aug. 8, 2002

(54) Method of providing roaming service for a mobile communication terminal

(75) Inventor: Sang-Uuk Song, Songnam-shi (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/023,639

(22) Filed: Dec. 17, 2001

(30) Foreign Application Priority Data
Feb. 5, 2001 (KR) 2001-5471

(51) Int. Cl. H04Q 7/20

(52) U.S. Cl. 455/432; 455/435; 455/566

(57) ABSTRACT

Disclosed is a method for enabling a mobile communication terminal to receive a roaming service. The method according to the invention includes the steps of receiving a system parameter message including a system ID from a base station by a mobile communication terminal of an idle state, determining whether or not the base station assists in a roaming service by means of the system ID, maintaining an idle state in the affirmative, and entering an out-of-service (OOS) state in the negative. The method according to the invention reduces unnecessary load of the system by minimizing the demands for a call to the base station that does not assist in a roaming service.

### PRIORITY

This application claims priority to an application entitled “Method of Providing a Roaming Service for Mobile Communication Terminal” filed with the Korean Industrial Property Office on Feb. 5, 2001 and assigned Serial No. 2001-5471, the contents of which are hereby incorporated by reference.

### BACKGROUND OF THE INVENTION

1. Field of the Invention

The present invention relates generally to a mobile communication terminal, and in particular, to a method for providing roaming services for a mobile communication terminal.

2. Description of the Related Art

A cellular mobile communication system enables a subscriber to continue communication while moving between cells by dividing an entire service area into a plurality of base stations (BS) and by intensively controlling the BS into a mobile switching center (MSC).

FIG. 1 is a diagram illustrating a construction of a conventional cellular mobile communication system. Referring to FIG. 1, the base stations 20, 30 transmit original identifying pilot signals, respectively, and perform communication by connecting a mobile communication terminal 10 to a radio channel from the corresponding cells.

The mobile communication terminal can be provided with roaming services according to an agreement between competing service providing systems while moving between the base stations belonging to the systems. As is well known, the roaming services enable the mobile communication terminal to communicate in a service area of a visiting system rather than in a service area of a registered home system. For that purpose, it is critical to check whether or not the visiting system has entered into a roaming agreement with the home system. Since each system has its own original system ID, the system ID is used for checking the existence of a roaming agreement.

In the roaming services utilized by a particular mobile communication terminal, the mobile communication terminal determines whether or not the current base station participates in the roaming services. Here, the current base station is defined to be a base station where a communication channel can be connected to the mobile communication terminal from its current position. For that purpose, the mobile communication terminal stores system identifications (IDs) in the name of a preferred roaming list. The preferred roaming list can be either recorded on a memory when manufacturing the mobile communication terminal or can be received from a base station. The system ID of the current base station is provided through a synchronous channel. If the system ID of the current base station is not on the pre-stored preferred roaming list, the mobile communication terminal enters an out-of-service (OOS) state. The mobile communication terminal in the OOS state does not require a system access even if the user attempts a call or a message requiring a response is received from the current station.

FIG. 2 is a flow chart illustrating an operation of a roaming service by a mobile communication terminal under the conventional technology. Referring to FIG. 2, if a base station transmits a synchronous channel message including a system ID in step S110, the mobile communication terminal receives the synchronous channel message and extracts the system ID in step S120. In step S130, the mobile communication terminal compares the extracted system ID with a pre-stored preferred roaming list, and confirms whether or not the base station participates in the roaming service in step S140. In the affirmative, the mobile communication terminal maintains an idle state in step S150 so as to be ready for a system access. In the negative, the mobile communication terminal enters the OOS state in step S160.

Meanwhile, the mobile communication terminal in the idle state moving between cells is automatically tuned with a base station having the most intensive pilot signal among the receivable pilot signals. Such a base station switching is referred to an idle handoff. The mobile communication terminal tuned with another base station due to the idle handoff prepares for a demand for a system access without receiving a new synchronous channel message.

As described above, the synchronous channel message is not received whenever the idle handoff is generated but is received when the mobile communication terminal is switched off or released after attempting a call or when moved from an OOS area to a service available area. Once initially synchronized data is acquired through a synchronous channel, the mobile communication terminal is transferred into a state of receiving a call channel without further monitoring the synchronous channel.

Accordingly, even after moving to a service area of a base station not providing a roaming service, the mobile communication terminal is unable to recognize the movement in a short period of time. For this reason, the mobile communication terminal is likely to demand the service station not providing a roaming service for a system access before receiving the synchronous channel message (system ID). Because of the inability to determine the roaming, the base station transfers the demand for a system access to an MSC. In that case, the MSC refuses a system access, and it may cause a problem by generating unnecessary load in the system.

### SUMMARY OF THE INVENTION

It is, therefore, an object of the present invention to provide a method for enabling a mobile communication terminal to receive a system ID of a base station through a paging channel and to determine the availability of a roaming service.

It is another object to provide a method for enabling a mobile communication terminal to receive a system ID of a base station through a system parameter message and to determine the availability of a roaming service.

To achieve the above objects, there is provided a method of providing a roaming service for a mobile communication terminal, comprising the steps of: receiving a system parameter message including a system ID from a base station through a paging channel at a mobile communication terminal; determining whether or not the base station participates in a roaming service by using the system ID; and maintaining an idle state in the affirmative, and entering an OOS state in the negative.

### BRIEF DESCRIPTION OF THE DRAWINGS

The above and other objects, features and advantages of the present invention will become more apparent from the following detailed description when taken in conjunction with the accompanying drawings, in which:

FIG. 1 is a diagram illustrating a construction of a conventional cellular mobile communication system;

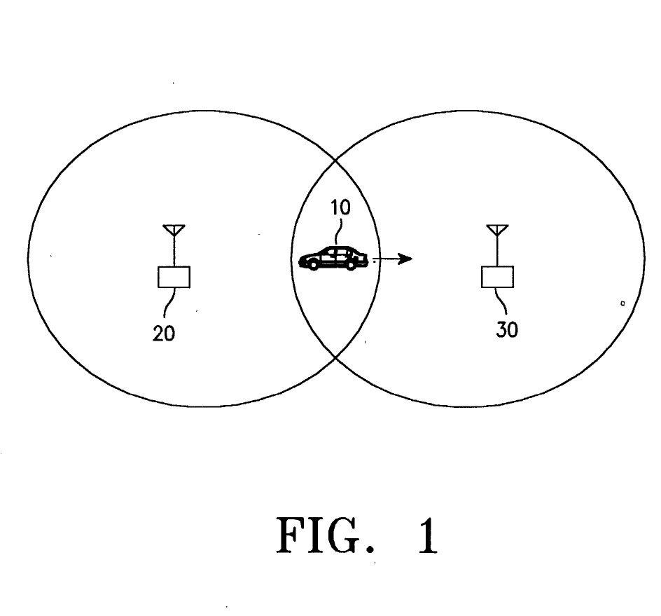

FIG. 2 is a flow chart illustrating an operation of a roaming service by a mobile communication terminal according to the related art; and

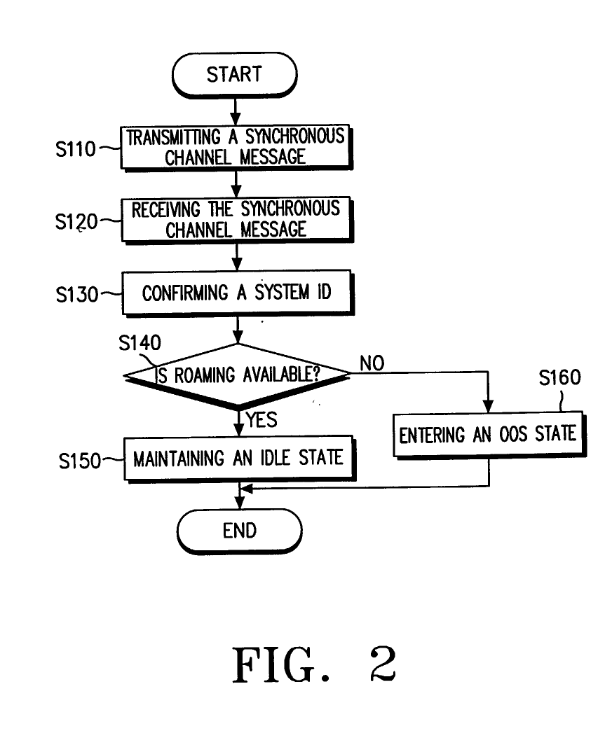

FIG. 3 is a flow chart illustrating an operation of a roaming service by a mobile communication terminal according to the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail. The terms to be described herein below are defined by considering their functions in the present invention, and may be variable depending on the intention of the user or according to practice. Therefore, those terms should be defined in light of the entire context of the specification.

Description of a forward link structure of a code-division multiple access system will precede description of a detailed operation of the present invention.

The base station satisfying an international standard (IS)-95 and a code-division multiple access standard based on the IS-95, transmits messages through a synchronous channel, a pilot channel, a paging channel and a traffic channel. The traffic channel transfers voice and data for communication. A pilot channel transfers a pilot signal having particular data (pilot offset) to identify a base station. The synchronous channel transfers only a single message that is referred to as a synchronous channel message. The mobile communication terminal receives system parameters, system time, and data transmitting velocity through the message.

In particular, the paging channel used in the present invention comprises a plurality of consecutive time slots, and transfers messages related to overhead, paging, command and channel distribution. Here, one of the overhead-related messages is a system parameter message. The system parameter message includes a pilot option, a system ID, a network ID, data related to registration of a position, latitude/longitude of the base station, data related to a slot mode, data related to a handoff, and data related to control of electric power. Such a system parameter message is repeatedly transmitted through a slot of the paging channel. Therefore, the mobile communication terminals can confirm the system ID of the current base station through the system parameter message.

According to known facts, the system parameter message is broadcasted to all mobile communication terminals through slots of the paging channel at least once every 1.28 seconds. Meanwhile, a special mode referred to as a slot mode is available in the paging channel. The mobile communication terminal in a slot mode receives messages through a designated time slot at predetermined time. However, the mobile communication terminal in the slot mode can confirm the system ID by receiving the system parameter message at least once every 1.28 seconds. Accordingly, the present invention more frequently confirms the system ID than the conventional art using a synchronous channel message, which can be received only when limited conditions are satisfied.

The following is a detailed description of a preferred embodiment of the present invention.

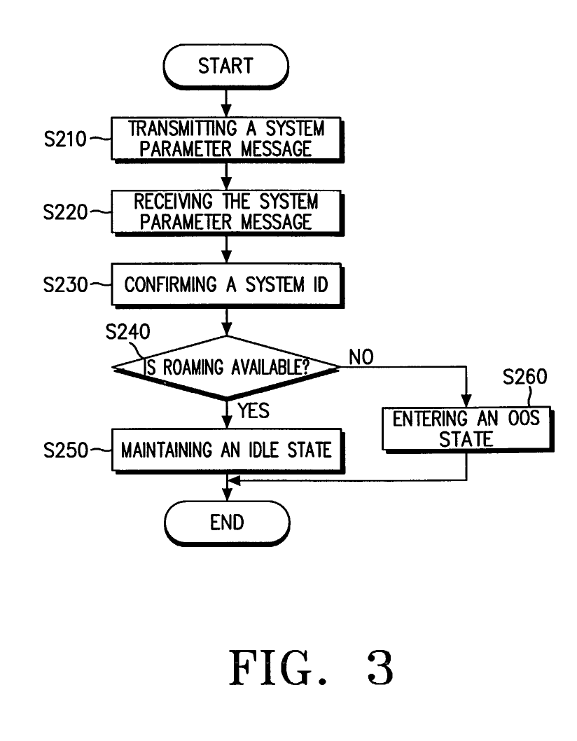

FIG. 3 is a flow chart illustrating an operation of a roaming service by a mobile communication terminal according to the present invention. Referring to FIG. 3, if a base station transmits a system parameter message through a paging channel in step S210, the mobile communication terminal extracts a system ID from the received system parameter message in step S220, and compares the extracted system ID with the pre-stored preferred roaming list (S230) to check whether or not the base station participates in the roaming service in step S240. In the affirmative, the mobile communication terminal maintains an idle state in step S250 to be ready for a system access. In the negative, the mobile communication terminal enters an OOS state in step S260.

In other words, the mobile communication terminal enters a service area of a base station not participating in a roaming service to perform an idle handoff, receives a system parameter message through a predetermined time slot of the paging channel, and extracts a system ID. The mobile communication terminal compares the extracted system ID with a pre-stored preferred roaming list. If the comparison finds that the current base station does not participate in the roaming service, the mobile communication terminal enters the OOS. At this stage, the preferred roaming list may store either the system IDS that can provide a roaming service for the mobile communication terminal or the system IDs that cannot provide a roaming service for the mobile communication terminal.

Meanwhile, the mobile communication terminal having entered into the OOS state does not demand the base station for a system access. At this stage, the mobile communication terminal displays either “an OOS state” or “no roaming service available” on a display screen so as to prevent unnecessary manipulation by the user.

The present invention operated as described above has an advantageous effect as briefly described herein below.

The present invention minimizes the demand for a call to a base station that does not participate in the roaming service by enabling the mobile communication terminal to determine whether or not the base station participates in the roaming service by means of a system parameter message. As a result, the present invention reduces unnecessary load of the system.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of providing a roaming service for a mobile communication terminal, the method comprising the steps of:
receiving a system parameter message including a system ID from a base station by a mobile communication terminal in an idle state;
determining whether or not the base station participates in a roaming service by utilizing the system ID;
maintaining the idle state if in the affirmative; and
entering an out-of-service (OOS) state if in the negative.

2. The roaming service method of claim 1, wherein the system parameter message is broadcasted to all mobile communication terminals through a paging channel.

3. The roaming service method of claim 1, wherein the system parameter message is transmitted in accordance with IS-95 standard criteria.

4. The roaming service method of claim 1, wherein the step of determining whether or not the base station participates in a roaming service is performed by comparing the system ID with a preferred roaming list stored in a memory of a mobile communication terminal.

5. The roaming service method of claim 4, wherein the preferred roaming list includes system IDs that can provide the mobile communication terminal with a roaming service.

6. The roaming service method of claim 4, wherein the preferred roaming list includes system IDs that cannot provide the mobile communication terminal with a roaming service.

7. The roaming service method of claim 1, wherein the mobile communication terminal entered into the OOS state displays “an OOS state” message on a display screen of the mobile communication terminal.

8. The roaming service method of claim 7, wherein the mobile communication terminal entered into the OOS state displays “an OOS state” on the display screen if user demands an outgoing call.

9. A roaming method for a mobile communication terminal that stores a preferred roaming list consisting of system IDs which participate in a roaming service, the method comprising the steps of:
receiving a system parameter message including a system ID from a base station through a paging channel by the mobile communication terminal in an idle state;
maintaining the idle state if the system ID is included in the stored preferred roaming list; and
entering an OOS state if the system ID is not included in the stored preferred roaming list.

10. A roaming method for a mobile communication terminal that stores a preferred roaming list consisting of system IDs which do not participate in a roaming service, the method comprising the steps of:
receiving a system parameter message including a system ID from a base station through a paging channel by the mobile communication terminal in an idle state;
maintaining the idle state if the system ID is not included in the stored preferred roaming list; and
entering an OOS state if the system ID is included in the stored preferred roaming list.
